(19) United States
(12) Patent Application Publication
(10) Pub. No.: US 2003/0047878 A1
(43) Pub. Date: Mar. 13, 2003

(54) Thermally stressable wall and method for sealing a gap in a thermally stressed wall

(76) Inventors: Hans-Thomas Bolms, Muelheim (DE); Peter Tiemann, Witten (DE)

Correspondence Address: HARNESS, DICKEY & PIERCE, P.L.C., P.O.BOX 8910, RESTON, VA, 20195, US

(21) Appl. No.: 10/181,525

(22) PCT Filed: Jan. 5, 2001
(86) PCT No.: PCT/EP01/00076

(30) Foreign Application Priority Data
Jan. 20, 2000 (EP) O0101113.9

(51) Int. Cl. F16J 15/34

(52) U.S. Cl. 277/359

(57) ABSTRACT

The invention relates to a wall (21) which can be thermally impinged upon by a hot gas (17). A gap (55) is created between a first segment (35) and a second segment (33) of the wall by deforming a bending element (45) of the second wall segment (33) at high temperatures. The bending element (45) is pressed against a pressing surface (49) of the first segment (35) of the wall. Deformation is caused by different types of thermal expansion of a hot and cold side of the bending element (45), whereby the gap (55) is sealed in a highly effective manner even at high temperatures.

The invention relates to a wall which can be thermally stressed by a hot gas, having a first wall segment and a second wall segment, which is immediately adjacent to the first wall segment with the formation of a gap. The invention also relates to a method for sealing a gap between a first and a second wall segment of a wall which is thermally stressed by a hot gas.

U.S. Pat. No. 5,221,096 shows a multilayer seal for reducing a cooling air leakage through a gap between two stages of a gas turbine engine. A first part of the seal is so thin that it is deformed under a pressure gradient in such a way that a sealing of the gap takes place. A second part of the seal is connected to the first part and has a configuration which is so thick that it provides the seal with stiffness. The assembly of the seal is facilitated by this stiffness.

EP 0 139 072 A1 shows a temperature-resistant, i-shaped spring seal. This seal can be advantageously employed in the case of very high and unevenly distributed temperatures.

U.S. Pat. No. 5,058,906 shows a seal ring. The metallic seal ring is configured in such a way that it can be elastically deformed. This makes it particularly suitable for the sealing of a conduit in which large temperature variations occur.

U.S. Pat. No. 4,537,024 shows the sealing of a gap in a gas turbine by means of a flexible seal ring, which is loop-shaped in cross section and is introduced into opposite grooves of two components between which there is a gap to be sealed.

A common feature of all these arrangements for sealing a gap is that a separate sealing element is used for the sealing. In a disadvantageous manner, the sealing effect of such a sealing element is dependent on temperature such that it becomes smaller, especially at high temperatures. In addition, the assembly of such a sealing element can be very complicated and difficult. Furthermore, such sealing elements are subject, precisely in the case of high temperature applications, to aging processes which substantially limit the life under certain circumstances.

The invention is correspondingly based on the object of providing a wall which can be thermally stressed by a hot gas and in which a gap between two wall segments of this wall can be sealed, in a simple manner and particularly effectively, especially at high temperatures. A further object of the invention is to provide a method for sealing a gap between two wall segments of a wall which is thermally stressed by a hot gas, which method can be carried out in a simple design manner and leads to good sealing, especially at high temperatures.

According to the invention, the object, pertaining to a wall, is solved by providing a wall which can be thermally stressed by a hot gas, having a first wall segment and a second wall segment, which is immediately adjacent to the first wall segment with the formation of a gap, the first wall segment having a contact surface and the second wall segment having a bending extension with a hot surface and a cold surface, the hot surface being more strongly heated than the cold surface under thermal stress, so that due to a different thermal expansion in the region of the hot surface, on the one hand, and of the cold surface, on the other, the bending extension bends so as to press against the contact surface and, by this means, bends so as to seal the gap.

The invention adopts the completely new path of sealing the gap between the wall segments by the wall segments themselves and not by a separate sealing element. This is achieved, especially at high temperatures, by a part of the first wall segment pressing, by means of a thermal bending process, onto a part of the second wall segment and, by this means, closing the gap. The thermal bending takes place in a manner similar to that of a bimetal strip, by means of the different thermal expansion of a cold and hot part of the wall segment. In contrast to the bimetal strip, however, the different thermal expansion is not, in the main, caused by different expansion coefficients of different materials but is due, in fact, to the different temperatures of the hot surface, on the one hand, and the cold surface, on the other. If appropriate, however, this effect can also be strengthened by a suitable material pairing, i.e. the bending can be strengthened by a pairing of materials of different thermal expansion coefficients. The bending extension is preferably a self-supporting protrusion of the wall segment, which is arranged to overlap the immediately adjacent wall segment.

An extension, which is deformed by the contact pressure between the bending extension and the contact surface and additionally seals the gap, is arranged on the bending extension or on the contact surface. A deformable coating is, furthermore, preferably applied to the bending extension or to the contact surface. A sealing material is preferably arranged between the bending extension and the contact surface.

Due to the extension, the coating or the sealing material, an additional sealing of the gap is achieved by means of a deformation of the coating, the sealing material or the extension material on the surfaces bounding the gap. Compensation can, in particular, be provided for smaller irregularities and unevenness between the bending extension and the contact surface.

The cold side can preferably be cooled by a cooling medium. Furthermore, the cooling medium is preferably cooling air. Such cooling can be necessary in the case of wall segments which are particularly highly thermally stressed. A leakage of this cooling medium occurs due to the gap. Such a frequently undesirable loss of cooling medium or the undesirable mixing of the cooling medium into the hot gas is combated by the sealing of the gap. This is—in addition to the sealing of the gap against the entry of hot gas—an advantage of the effective gap sealing, and of the particularly effective gap sealing, especially at high temperatures.

The wall is preferably embodied as a flow duct wall of a thermal turbomachine, and more preferably as a flow duct wall of a gas turbine. Particularly high temperatures occur in a gas turbine both in a combustion zone, i.e. of a combustion chamber, and in a flow duct of a gas turbine, due to the hot gas flowing through the gas turbine. Guidance of the hot gas by a wall, which can be very highly thermally stressed, is necessary in this case. Such a wall must, as a rule, be effectively cooled by cooling air. This cooling air is frequently extracted from a compressor of the gas turbine. This reduces the efficiency of the gas turbine because the cooling air is not supplied to a combustion system with the necessary pressure. In order to maintain as high an efficiency as possible, therefore, the cooling air requirement should be kept as small as possible. Particularly in a gas turbine, therefore, gaps between wall segments of the thermally stressed wall must be particularly well sealed against a leakage of cooling air.

The first wall segment is preferably embodied as a guide ring for a rotor blade ring and the second wall segment is preferably embodied as a platform ring of a guide vane ring. The second wall segment is preferably embodied as a guide ring for a rotor blade ring and the first wall segment is preferably embodied as a platform ring of a guide vane ring. The flow duct of a gas turbine has, in alternating sequence, guide vanes and rotor blades arranged in respective guide vane rings and rotor blade rings. A guide ring is arranged on the casing side opposite to a rotating rotor blade ring connected to a gas turbine rotor. The guide vanes each have a platform at the blade root end, which platforms together form a platform ring which bounds the flow duct on the casing side. Platforms arranged at the tip part of each guide vane form a platform ring for bounding the flow duct on the rotor side. The alternating sequence of guide rings and platform rings forms wall segments between which there remains a gap. As described above, this gap is sealed by the bending capability of the bending extension.

In a preferred embodiment, the wall is configured as a combustion chamber lining, in particular of a gas turbine combustion chamber. In this arrangement, the combustion chamber lining is built up from wall segments respectively overlapping by means of the bending extension and the contact surface. As an example, such a wall segment could be a combustion chamber brick which has a bending extension on one side and a contact surface on an opposite side, so that each wall segment has both an active and a passive sealing region, i.e. one region bends actively to seal the gap whereas the other region passively accepts the contact pressure of the adjacent bending extension. Simultaneously effecting such passive and active sealing regions with a single wall segment is not, of course, only conceivable for the combustion chamber lining but is also conceivable in any wall structure which can be thermally stressed.

According to the invention, the object pertaining to a method is achieved by the provision of a method for sealing a gap between a first and a second wall segment of a wall which is thermally stressed by a hot gas, a bending extension of the first wall segment being pressed by a heating process against a contact surface of the second wall segment in such a way that a sealing of the gap occurs.

Corresponding to the above considerations, the advantages of such a method result from the advantages of the wall which can be thermally stressed.

The invention is explained in more detail, as an example, using the drawings. Diagrammatically, and not to scale, in some cases:

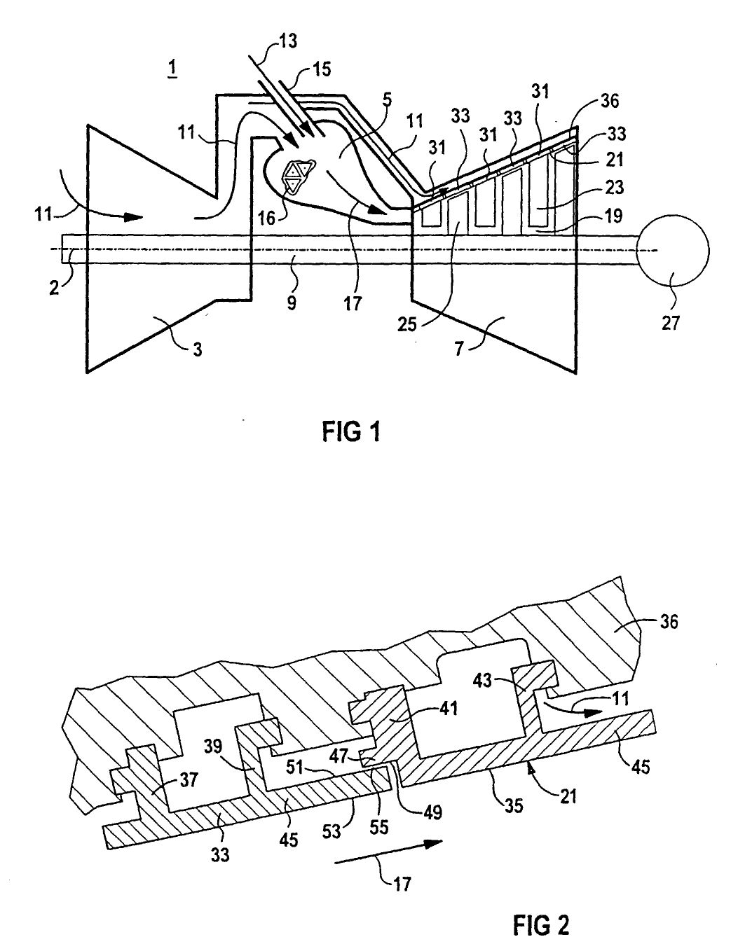

FIG. 1 shows a gas turbine in a longitudinal section,

FIG. 2 shows a wall which can be thermally stressed, in a longitudinal section,

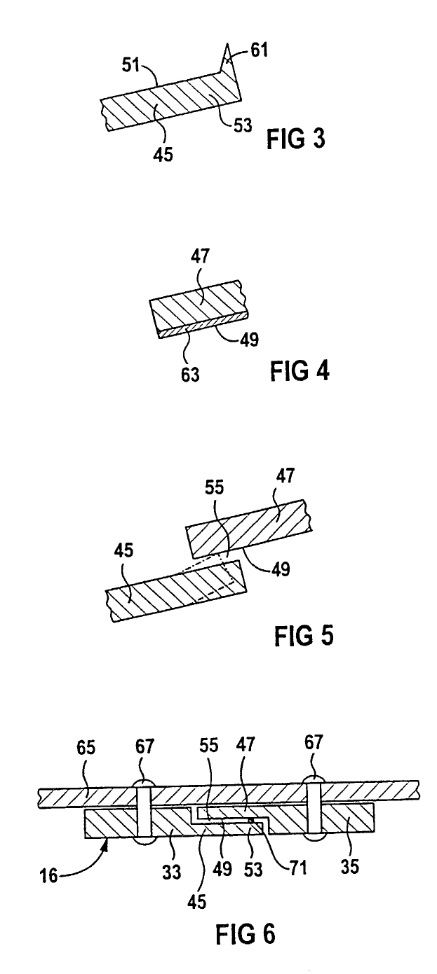

FIG. 3 shows a bending extension with additional extension,

FIG. 4 shows a contact surface with a deformable coating,

FIG. 5 shows a gap between two adjacent wall segments in the cold and hot condition and

FIG. 6 shows a part of a combustion chamber lining.

Similar designations have the same significance in the various figures.

FIG. 1 shows, diagrammatically and in a longitudinal section, a gas turbine 1. Arranged one behind the other along a turbine center line 2, there are: a compressor 3, an annular combustion chamber 5 and a turbine part 7. The compressor 3 and the turbine part 7 are arranged on a rotor 9. Air 11 is compressed in the compressor 3 and supplied to a burner 15. Fuel 13 is also supplied to the burner 15. The air 11 and the fuel 13 are burned to form a hot exhaust gas 17 in the annular combustion chamber 5, which is provided with a combustion chamber lining 16. The hot gas 17 is supplied to the turbine part, 7. The turbine part 7 has a flow duct 19. The flow duct 19 is bounded by a wall 21, which can be thermally stressed. The wall 21 which can be thermally stressed is built up from wall segments 33, 35. Some of the wall segments are configured by means of guide rings 35 and some other wall segments are configured as platform rings 33. The guide rings 33 are arranged opposite to rotor blades 25 arranged on the rotor 9. The platform rings 33 are part of a guide vane ring 33 connected to the casing. Apart from being guided to the burner 15, air 11 from the compressor 3 is also guided to the turbine part 7 and is used inter alia for cooling the wall segments 33, 35. A gap, through which a cooling air leakage occurs, remains between the wall segments 33, 35. The sealing of this gap in order to reduce the loss of cooling air is described in more detail using FIG. 2.

FIG. 2 shows a casing 36 of a gas turbine 1 arranged immediately adjacent to one another a platform ring 33 and a guide ring 35. The platform ring 33, i.e. including also the respectively associated guide vane ring 23 (not shown in any more detail here), is connected to the casing 36 by means of a first hook arrangement 37 and a second hook arrangement 39. The guide ring 35 is connected to the casing 36 by means of a first guide ring hook arrangement 41 and a second guide ring hook arrangement 43. The respectively first and second hook arrangements 37, 39 and 41, 43 of the platform ring 33 and of the guide ring 35 are sufficiently far removed from a respective edge of the platform ring 33 and of the guide ring 35 that, both for the platform ring 33 and for the guide ring 35 on the end away from the flow, referred to the flow direction of the hot gas 17, there is a self-supporting bending extension 45. A contact base 47 is configured on the side respectively opposite to this bending extension 45, which contact base overlaps the bending extension 45 of the adjacent wall segment in the flow direction of the hot gas 17. Each bending extension 45 has a hot surface 53 exposed to the hot gas 17 and a cold surface 51 opposite to the hot surface 53. A gap 55 forms between each bending extension 45 and the contact surface 49 opposite to it due to the overlap. Due to the hot gas 17, the hot surface 53 of the bending extension 45 is more strongly heated than the cold surface 51. In consequence, the region of the bending extension 45 bounding the hot surface 53 expands more strongly than the region bounding the cold surface 51. Because of this different thermal expansion, the bending extension 45 bends in the direction towards the opposite contact surface 49 of the following wall segment 35. In this process, the bending extension 45 presses on the contact surface 49. The gap 55 is sealed by this means. A leakage of cooling air 11 is reduced or, indeed, completely avoided by this means. No separate sealing element is necessary in this configuration. In particular, however, the sealing effect caused by the thermal bending leads to particularly good sealing, especially at high temperatures. In the case of a conventional seal with a separate sealing element, the sealing effect usually deteriorates at higher temperatures.

FIG. 3 shows a bending extension 45 in which an additional extension 61 is arranged at the end on the cold surface. The thickness and shape of this additional extension 61 is designed in such a way that it deforms in the case of contact pressure between the bending extension 45 and the contact surface 49 and, in the process, provides compensation for any unevenness and irregularities between the bending extension 45 and the contact surface 49. This results in a further improved sealing effect for sealing the gap 55. In particular, the deformation of the additional extension 61 takes place elastically.

FIG. 4 shows a further possibility for improving the sealing effect. In this case, the contact surface 49 is provided with a deformable coating 63. This likewise leads to a compensation for any unevenness between the bending extension 45 and the contact surface 49. The coating 63 can, of course, also be arranged on the bending extension 45, just as the additional extension 61 can also be arranged on the contact surface 49.

FIG. 5 shows a bending extension 45 and an overlapping opposite contact extension 47, with associated contact surface 49, in the cold condition. In this condition, the bending extension 49 is not bent and the gap 55 is open. The shape of the bending extension 45 at high temperatures is represented by an interrupted line. In this case, the bending extension 45 is bent in such a way that the gap 55 is closed. The bending extension 55 then presses onto the contact surface 49.

FIG. 6 shows a part of a combustion chamber lining 16, which represents a wall 21 which can be thermally stressed. A first wall segment 35 and a second wall segment 33 are connected to a supporting wall 65 by respective pins 67. Corresponding to the above representation, a bending extension 45 of the first wall segment 35 overlaps a contact extension 47 of the second wall segment 33. The gap 55 remains between the bending extension 45 and the contact extension 47. At high temperatures, this gap 55 is sealed by the bending extension 45 bending, as explained in more detail above. In addition the gap 55 is arranged a sealing material 71 which deforms when contact pressure occurs between the bending extension 45 and the contact surface 49 and, in the process, provides compensation for any unevenness in such a way that an additional sealing effect is achieved.

1. A wall (21) which can be thermally stressed by a hot gas (17), having a first wall segment (35) and a second wall segment (33), which is immediately adjacent to the first wall segment (35) with the formation of a gap (55), characterized in that the first wall segment (35) has a contact surface (49) and the second wall segment (33) has a bending extension (45) with a hot surface (53) and a cold surface (51), the hot surface (53) being more strongly heated than the cold surface (51) under thermal stress, so that due to a different thermal expansion in the region of the hot surface (53), on the one hand, and of the cold surface (51), on the other, the bending extension (45) bends so as to press against the contact surface (49) and, by this means, bends so as to seal the gap (55).

2. The wall (21) as claimed in claim 1, characterized in that an extension (61), which is deformed by the contact pressure between the bending extension (45) and the contact surface (45) and additionally seals the gap (55), is arranged on the bending extension (45) or on the contact surface (49).

3. The wall (21) as claimed in claim 1 or 2, characterized in that a deformable coating (63) is applied to the bending extension (45) or to the contact surface (49).

4. The wall (21) as claimed in claim 1, 2 or 3, characterized in that a sealing material (71) is arranged between the bending extension (45) and the contact surface (49).

5. The wall (21) as claimed in one or more of the preceding claims, characterized in that the cold side (51) can be cooled by a cooling medium (11).

6. The wall (21) as claimed in one or more of the preceding claims, characterized by an embodiment as a flow duct wall of a thermal turbomachine (1).

7. The wall (21) as claimed in claim 6, characterized by an embodiment as a flow duct wall of a gas turbine (1).

8. The wall (21) as claimed in claim 7, characterized in that the first wall segment (35) is embodied as a guide ring for a rotor blade ring (25) and the second wall segment (33) is embodied as a platform ring of a guide vane ring (23).

9. The wall (21) as claimed in claim 7, characterized in that the second wall segment (33) is embodied as a guide ring for a rotor blade ring (25) and the first wall segment (35) is embodied as a platform ring of a guide vane ring (23).

10. The wall (21) as claimed in one of claims 1 to 5, characterized by an embodiment as a combustion chamber lining (16), in particular of a gas turbine combustion chamber (5).

11. A method for sealing a gap (55) between a first and a second wall segment (35, 33) of a wall (21) which is thermally stressed by a hot gas (17), characterized in that a bending extension (45) of the first wall segment (35) is pressed by a heating process against a contact surface (49) of the second wall segment (33) in such a way that a sealing of the gap (55) occurs.
